(19) United States
(12) Patent Application Publication
(10) Pub. No.: US 2024/0219683 A1
(43) Pub. Date: Jul. 4, 2024

(54) PRISMATIC MOTOR

(71) Applicant: Lanto Electronic Limited, Kunshan City (CN)

(72) Inventor: Fu-Yuan WU, Kunshan City (CN)

(21) Appl. No.: 18/354,882

(22) Filed: Jul. 19, 2023

(30) Foreign Application Priority Data
Dec. 30, 2022 (CN) 2022117233554

(51) Int. Cl. G02B 7/18

(52) U.S. Cl. CPC G02B 7/1805

(57) ABSTRACT

A prismatic motor for driving a prism includes: a first holder, a second holder and a cylinder. A prism is disposed on the first holder. The first holder includes a first clamping part. The second holder includes a second clamping part which is correspondingly disposed with the first clamping part. The cylinder is disposed between the first clamping part and the second clamping part, and the cylinder radially separates the first holder from the second holder. The first holder may rotate along the circumference direction of the cylinder. The prismatic motor solves a problem that dropping the rolling body of the conventional prismatic motor during assembly is easy.

### FIELD OF THE INVENTION

The present disclosure relates to an image capturing device, and particularly relates to a prismatic motor.

### BACKGROUND OF THE INVENTION

In order to achieve a high optical zoom ratio of a camera in an electronic device (e.g., a smart phone or a panel computer) and to meet a requirement about the light and thin electronic device at the same time, a periscope lens set and a focus lens set may be disposed in the camera. The periscope lens set includes a prism and a prism carrier. The focus lens set includes a lens and a focus lens. In order to prevent the camera from jittering when an image is formed, a prismatic motor may be disposed in the periscope lens set and a focus motor may be disposed in the focus lens. The prismatic motor may do optical image stabilization (OIS) dual axes rotation. The prismatic motor drives the prism to rotate, the focus motor drives the lens to move, and the OIS of the lens is achieved by cooperating the rotation of the prism and the moving of the lens such that the image of the camera would be clearer.

In order to achieve that the prism rotates around an axis line with a particular direction, the prism carrier, a frame and a rolling body may be disposed below the prism. The prism is fixed on the prism carrier, two arc paths are disposed on the prism carrier and the frame, and the rolling body is disposed between the two arc paths. The prism carrier may slide along the two arc paths to fulfill the rotation relative to the frame. Because the two arc paths are vertically disposed or obliquely disposed, the rolling body would be dropped when the rolling body is mounted between the two arc paths: or because the rolling body is circular, positioning the rolling body is difficult and it is easy to roll the rolling body when the prism carrier, the frame and the rolling body are assembled together. Therefore, the conventional prismatic motor has a problem that the rolling body during assembly is easy to drop or that the prism carrier, the frame and the rolling body is difficult to assemble together.

### SUMMARY OF THE INVENTION

The object of the present disclosure is to provide a prismatic motor which solves a problem that the rolling body of the conventional prismatic motor during assembly is easy to drop. The prismatic motor for driving a prism includes: a first holder, a second holder and a cylinder. The first holder is for holding the prism and includes a first clamping part. The second holder includes a second clamping part being correspondingly disposed with the first clamping part. The cylinder is located between the first clamping part and the second clamping part and radially separates the first holder from the second holder, wherein the first holder is configured to rotate along a circumference direction of the cylinder.

In some embodiments, the first holder further includes a boss which protrudes outwards, and the first clamping part is located on the boss. The first holder is for holding the prism on a direction opposite to a protruding direction of the boss.

In some embodiments, the number of the bosses is two and the two bosses are disposed horizontally and outwards. The first holder is for holding the prism between the two bosses. The number of the first clamping parts corresponds to the number of the bosses, the first clamping part is vertically located below the boss, and the second clamping part is vertically located above the second holder.

In some embodiments, the second holder includes an arm which is correspondingly disposed with the boss and the second clamping part is located on the arm.

In some embodiments, a number of the arms is two and corresponds to a number of the second clamping parts, and the two arms are disposed horizontally.

In some embodiments, the number of the cylinders is two and corresponds to the number of the first clamping parts and the number of the second clamping parts, and the two cylinders are coaxially disposed.

In some embodiments, the first clamping part is a concave groove with rectangular cross-section, and the second clamping part is a concave groove with trapezoidal cross-section.

In some embodiments, the first clamping part includes a first groove bottom surface. The second clamping part includes a second groove bottom surface and two slanted surfaces which are relatively disposed and are connected to the second groove bottom surface. The first groove bottom surface and the two slanted surfaces are respectively in line contact with the cylinder, and there is a gap between the cylinder and the second groove bottom surface.

In some embodiments, the prismatic motor further includes: a base, a first magnetic body and a first circuit board. The first magnetic body is disposed on the first holder. The first circuit board is disposed on the base and includes a first coil which is corresponding disposed with the first magnetic body. The first coil is configured to generate first magnetic force interacting with the first magnetic body after the first coil is charged with electricity in order to push the first holder to rotate along a circumference direction of the cylinder.

In some embodiments, the prismatic motor further includes a magnetically permeable component which is disposed on the base and is correspondingly disposed with the first magnetic body.

In some embodiments, the first coil is disposed on one surface of the first circuit board close to the first magnetic body, and the magnetically permeable component is disposed on one surface of the first circuit board far from the first magnetic body.

In some embodiments, the prismatic motor further includes: a second circuit board and a second magnetic body. The second circuit board includes a second coil. The second magnetic body is disposed on the second holder, corresponds to the second coil. The second coil is configured to generate second magnetic force interacting with the second magnetic body after the second coil is charged with electricity in order to push the second holder to rotate. The magnetically permeable component includes a main body, a first extension part and a second extension part. The main body is correspondingly disposed with the first magnetic body. The first extension part and the second extension part are respectively on relative two sides of the main body and the first extension part and the second extension part extend along the relative two sides of the second magnetic body.

In some embodiments, there are contact points disposed on one side of the first circuit board and arranged along a predetermined direction. The magnetically permeable component further includes a support part located on one side of the first extension part far from the main body and being correspondingly disposed with the contact points.

In some embodiments, the prismatic motor further includes: a first accommodation part, a second accommodation part and a rolling body. The first accommodation part is disposed on the second holder. The second accommodation part is correspondingly disposed with the first accommodation part and defines a rolling space with the first accommodation part. The rolling body is located in the rolling space and is configured to roll in the rolling space. The second holder is configured to rotate along the rolling space.

In some embodiments, the number of the first accommodation parts and the number of the second accommodation parts are respectively two. The number of the rolling spaces is two. The two rolling spaces include at least one directional channel, the rolling body is configured to roll in the directional channel, and the second holder is configured to rotate along the directional channel.

In some embodiments, the prismatic motor further includes: a second circuit board and a second magnetic body. The second circuit board includes a second coil. The second magnetic body is disposed on the second holder and corresponds to the second coil. The second coil is configured to generate second magnetic force interacting with the second magnetic body after the second coil is charged with electricity in order to push the second holder to rotate along the directional channel.

In some embodiments, the first holder further includes two bosses disposed horizontally and outwards. The first holder is for holding the prism between the two bosses. The second holder further includes a backboard and two arms respectively located on two sides of the backboard, and there is an avoidance space formed between the backboard and the two arms. The first holder is disposed in the avoidance space and the two arms are correspondingly disposed with the two bosses respectively.

In some embodiments, the prismatic motor further includes: a base, a first magnetic body and a first circuit board. The first magnetic body is disposed on a platform of a bottom of the first holder. The first circuit board is disposed on the base and includes a first coil which is correspondingly disposed with the first magnetic body. The platform approaches the first circuit board by the avoidance space and the first magnetic body is close to the first coil and there is a gap between the first magnetic body and the first coil.

In some embodiments, the prismatic motor further includes: a second circuit board and a second magnetic body. The second circuit board includes a second coil. The second magnetic body is disposed on the backboard of the second holder, corresponds to the second coil and is close to the second coil. There is a gap between the second magnetic body and the second coil.

The present disclosure further provides a prismatic motor. The prismatic motor for driving a prism includes: a first holder, and a second holder. The first holder includes two bosses and two first clamping parts. The two bosses are disposed horizontally and outwards, and the first holder is for holding the prism between the two bosses. The two first clamping parts are located on the two bosses respectively. The second holder includes a backboard, two arms located on two sides of the backboard, and two second clamping parts. The two second clamping part are located on the two arms respectively. There is an avoidance space formed between the backboard and the two arms. The first holder is disposed in the avoidance space. The two arms are correspondingly disposed with the two bosses respectively. The second clamping parts is rotatably connected to the two first clamping part, and the first holder is configured to rotate relative to the second holder by the first clamping part and the second clamping part.

The beneficial effect of the present disclosure: because the second clamping part is located below the first clamping part, the cylinder may be placed on the second clamping part when the cylinder is mounted between the first holder and the second holder, and then the first clamping part clamps the cylinder in the radial direction of the cylinder such that the first clamping part and the second clamping part may contact and clamp the cylinder in the radial direction of the cylinder, and further the cylinder could not be dropped due to rolling when the cylinder is mounted between the first holder and the second holder, and positioning the cylinder between the first holder and the second holder becomes easy and it becomes easy for the first holder, the second holder and the cylinder to assemble together.

The aforementioned description of the present disclosure is merely the outline of the technical solutions of the present disclosure. In order to understand the technical solutions of the present disclosure clearly and to implement the present disclosure according to the content of the specification. The better embodiments of the present disclosure given herein below with accompanying drawings are used to describe the present disclosure in detail.

### BRIEF DESCRIPTION OF THE DRAWINGS

FIG. 1 is an exploded view diagram of a prismatic motor (including a prism and sectioning one arm of a second holder) according to one embodiment of the present disclosure.

FIG. 2 is a 3D cross section view diagram of a prismatic motor (including a prism but omitting a case and a cylinder) according to one embodiment of the present disclosure.

FIG. 3 is a cross section view diagram of a prismatic motor (including a partial enlarged view diagram of surroundings of a cylinder) according to one embodiment of the present disclosure.

FIG. 4 is an exploded view diagram of a first holder and a prism (sectioning one boss of a first holder) according to one embodiment of the present disclosure.

FIG. 5 is a 3D diagram of a second holder according to one embodiment of the present disclosure.

FIG. 6 is a 3D cross section view diagram of a prismatic motor (including a prism but omitting a case and one rolling body in a directional channel) according to one embodiment of the present disclosure.

FIG. 7 is a 3D cross section view diagram of a prismatic motor (including a prism but omitting a first magnetic body) according to one embodiment of the present disclosure.

FIG. 8 is a top view diagram of a prismatic motor (sectioning a first circuit board but omitting a base, a case, a first holder, a second holder, a rolling body and a prism) according to one embodiment of the present disclosure.

FIG. 9 is a 3D view diagram of a first holder, a first magnetic body, a second holder and a second magnetic body after assembly according to one embodiment of the present disclosure.

FIG. 10 is a block diagram of an intelligent terminal according to another embodiment of the present disclosure.

### DETAILED DESCRIPTION

The specific embodiments of the present disclosure given herein below is used to explain the implementation of the present disclosure. A person skilled in the art easily understands the advantages and the effects of the present disclosure from the content of the present disclosure.

It should be noted that the embodiments and the features in the embodiments of the present disclosure can be combined with each other without conflict. The present disclosure will be described in detail below with reference to accompanying drawings and in conjunction with the embodiments. In order to provide those in the art with better understanding of the solution of the disclosure, the technical solutions in the embodiments of the present disclosure will be described clearly and completely below in conjunction with the accompanying drawings in the embodiments of the present disclosure. Apparently, the described embodiments are merely a part of the embodiments of the present disclosure and not all embodiments of the present disclosure. Based on the embodiments of the present disclosure, all other embodiments obtained by a person skilled in the art shall fall within the scope of protection of the present disclosure.

It should be noted that the terms “first”, “second”, etc. in the specification and claims of the present disclosure and in the aforementioned accompanying drawings are used to distinguish similar objects and need not be used to describe a particular order or sequence. Furthermore, the terms “comprising” and “having”, and any variation thereof, are intended to encompass a non-exclusive inclusion, for example, a series of steps or units comprising processes, methods, systems, products or equipment need not be limited to those steps or units clearly listed but may include other steps or units not clearly listed or inherent to those processes, methods, products or equipment.

It should be noted that the terms “mount”, “connect”, “link” should be broadly interpreted, for example, may be a permanent connection, may be a dismountable connection or may be an integral connection: may be a mechanical connection or may be an electrically connection: may be a direct connection, may be a connection by intermediate mediums, or may be an interior connection between two components. For a person skilled in the art, the meaning of the aforementioned terms in the present disclosure may be understood upon specific situations.

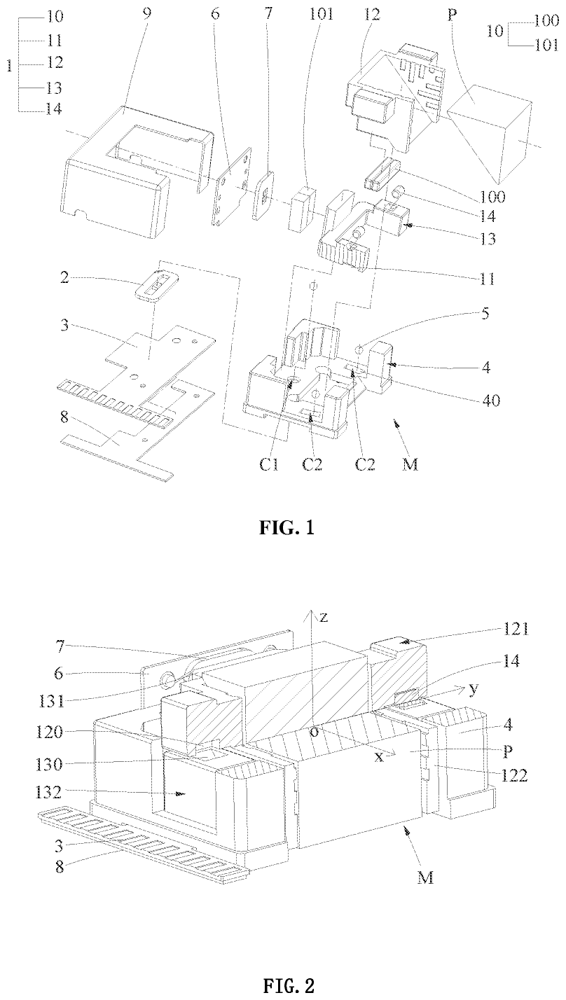

As shown in FIG. 1, the present disclosure in one embodiment provides a prismatic motor M including: a holding component 1, a first circuit board 3, a base 4, a plenty of rolling bodies 5 (for example, three rolling bodies), a second circuit board 6, a magnetically permeable component 8 and a case 9. The holding component 1 includes a magnetic body 10, a plenty of first accommodation parts 11 (for example, three first accommodation parts), a first holder 12, a second holder 13 and two cylinders 14. The first circuit board 3 includes a first coil 2. The second circuit board 6 includes a second coil 7. The magnetic body 10 includes a first magnetic body 100 and a second magnetic body 101. A prism P is disposed on the holding component 1, and the prism P is disposed on the first holder 12, for example.

As shown in FIG. 2, the present disclosure in one embodiment provides a prismatic motor M for driving a prism P. The prismatic motor M includes: the first holder 12 (the first holder 12 may refer to FIG. 1, similarly hereinafter), the second holder 13 (the second holder 13 may refer to FIG. 1, similarly hereinafter) and the cylinders 14. The prism P is disposed on the first holder 12, and the first holder 12 includes a first clamping part 120. The second holder 13 includes a second clamping part 130, and the second clamping part 130 is correspondingly disposed with the first clamping part 12, and for example, the second clamping part 130 may be located below the first clamping part 120. Each of the cylinders 14 is located between the first clamping part 120 and the second clamping part 130, and the first clamping part 120 and the second clamping part 130 contact the cylinders 14 in the radial direction of the cylinders 14, and the cylinders 14 radially separate the first holder 12 from the second holder 13. For example, after the cylinders 14 separate the first holder 12 from the second holder 13, the first holder 12 and the second holder 13 may be parallel to each other and form a gap. The first holder 12 may rotate along the circumference direction of the cylinders 14. For example, the first holder 12 may rotate around the central axis line of the two cylinders 14.

As shown in FIG. 2, the first holder 12 (the first holder 12 may refer to FIG. 1, similarly hereinafter) includes two first clamping parts 120. For convenience to explain, Cartesian coordinate system O-xyz may be disposed in the prismatic motor M such that y-axis of the Cartesian coordinate system O-xyz overlaps the central axis line of the two cylinders 14 and original point of the Cartesian coordinate system O-xyz may be located on a middle position between the two cylinders 14. The two first clamping parts 120 are disposed at intervals. The two first clamping parts 120 may be symmetrically disposed with respect to XoZ plane. The two first clamping parts 120 themselves may be symmetrical with respect to YoZ plane. The two first clamping parts 120 may be first concave grooves. For example, the two first clamping parts 120 may be rectangle holes, the length of each of the two first clamping parts 120 is approximately equal to the length of each of the two cylinders 14 and the depth each of the two first clamping parts 120 is less than the radius of each of the two cylinders 14.

As shown in FIG. 2, the second holder 13 (the second holder 13 may refer to FIG. 1, similarly hereinafter) includes two second clamping parts 130, and the two second clamping parts 130 are located below the two first clamping parts 120. The two second clamping parts 130 are vertically located (e.g., a vertical direction is z-axis direction) on the second holder 13. The two second clamping parts 130 are disposed at intervals. The two second clamping parts 130 may be symmetrically disposed with respect to the XoZ plane. The two second clamping parts 130 themselves may be symmetrical with respect to the YoZ plane. One cylinder 14 is disposed between each of the two first clamping parts 120 and each of the two second clamping parts 130. The two second clamping parts 130 may be located directly below the two first clamping parts 120, and the two second clamping parts 130 are disposed in alignment with the two first clamping parts 120. The two second clamping parts 130 may be second concave grooves. For example, the cross sections of the two second clamping parts 130 may be trapezoids (the width of each of the trapezoids may be gradually decreased from top to bottom, and in other word the bottom side of each of the trapezoids may be on a top surface of an arm 132), and the length of each of the two second clamping parts 130 is approximately equal to the length of each of the cylinders 14.

As shown in FIG. 2, the first clamping parts 120 and the second clamping parts 130 contact the cylinders 14 in the radial direction of the cylinders 14. Clamping the first clamping part 120 and the second clamping part 130 means that after the cylinder 14 is clamped between the first clamping part 120 and the second clamping part 130 from the radial direction of the cylinder 14, the cylinder 14 would not be dropped from the first clamping part 120 or the second clamping part 130, and any component with the aforementioned function of clamping may be regarded as the clamping part. The cross sections of the cylinders 14 may be circles. The cylinders 14 radially separates the first holder 12 from the second holder 13 (the first holder 12 and the second holder 13 may refer to FIG. 1, similarly hereinafter). The number of the cylinders 14 may be two, the number of the first clamping parts 120 corresponds to the number of the cylinders 14 and the number of the second clamping parts 130 corresponds to the number of the cylinders 14. The two cylinders 14 are separate and are coaxially disposed, and after the two cylinders 14 separates the two first clamping parts 120 from the two second clamping parts 130, there is a gap between the first holder 12 and the second holder 13 such that a space is provided to the first holder 12 to rotate along the circumference direction of the two cylinders 14. The two cylinders 14 may be symmetrically disposed with respect to the XoZ plane. The two cylinders 14 themselves may be symmetrical with respect to the YoZ plane. The first holder 12 may rotate along the circumference direction of the two cylinders 14. For example, the first holder 12 may rotate around the y-axis. How the first holder 12 rotates along the circumference direction of the two cylinders 14 may refer to the following embodiments.

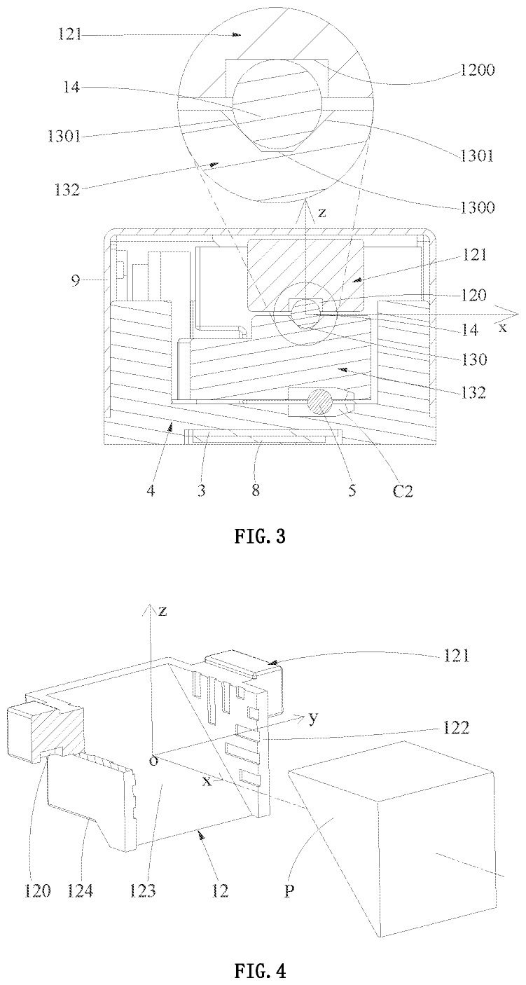

As shown in FIG. 3, each of the two first clamping parts 120 is a concave groove with rectangular cross-section, and each of the two second clamping parts 130 is a concave groove with trapezoidal cross-section. Each of the two first clamping parts 120 includes a first groove bottom surface 1200, and each of the two second clamping parts 130 includes a second groove bottom surface 1300 and two slanted surfaces 1301 which are relatively disposed and are connected to the second groove bottom surface 1300. The first groove bottom surface 1200 and the corresponding two slanted surfaces 1301 are respectively in line contact with the corresponding cylinder 14, and there is a gap between the cylinder 14 and the corresponding second groove bottom surface 1300. Each of the second clamping parts 130 is rotatably connected to each of the first clamping parts 120, and the first holder 12 (the first holder 12 and the second holder 13 may refer to FIG. 1, similarly hereinafter) is configured to rotate relative to the second holder 13 by the two first clamping parts 120 and the two second clamping part 130. The first groove bottom surface 1200 and the second groove bottom surface 1300 may be parallel to each other and may be parallel to XoY plane, and the two slanted surfaces 1301 may be symmetrically disposed with respect to the YoZ plane.

Because the second clamping part 130 is located below the first clamping part 120, the cylinder 14 may be placed on the second clamping part 130 when the cylinder 14 is mounted between the first holder 12 and the second holder 13, and then the first clamping part 120 clamps the cylinder 14 in the radial direction of the cylinder 14 such that the first clamping part 120 and the second clamping part 130 may contact and clamp the cylinder 14 in the radial direction of the cylinder 14, and further the cylinder 14 would not be dropped due to rolling when the cylinder 14 is mounted between the first holder 12 and the second holder 13, and positioning the cylinder 14 between the first holder 12 and the second holder 13 becomes easy and it is easy for the first holder 12, the second holder 13 and the cylinder 14 to assemble together. Besides, the holding component 1 is divided into the first holder 12 and the second holder 13, and the first holder 12 and the second holder 13 are two motion structures having rotation abilities with different direction such that degree of freedom of space motion is increased, stability of system is elevated, and the interference between the two motion structures would be decreased, and for example, if the holding component 1 is a single holder, it is easy to generate dynamic interference.

As shown in FIG. 4, in some embodiments, the first holder 12 further includes at least one boss 121 (for example, two bosses), two side plates 122 which are parallel to each other and a slanted plate 123. The slanted plate 123 is between the two side plates 122 and may be integrally formed with the bottoms of the two side plates 122, the two side plates 122 and the slanted plate 123 defines an accommodation space, and the prism P is in the accommodation space. The cross section of the prism P may be a right triangle, two vertical planes of the prism P may be respectively vertical to x-axis and z-axis, and a slanted plane of the prism P may be attached to the slanted plate 123. For example, the two bosses 121 may protrude outwards and may protrude from the exterior wall of the two side plates 122, and the prism P is on the direction opposite to the protruding direction of the two bosses. The two bosses 121 are disposed horizontally and outwards. The two bosses 121 may be cuboids, and each of the boss two bosses 121 may be vertically disposed with the exterior wall of the corresponding side plate 122 respectively. Each of the boss two bosses 121 may be disposed on a middle position of the upper of the corresponding side plate 122. The two bosses 121 are disposed at intervals, the prism P is located between the two bosses 121, and each of the two bosses 121 includes one first clamping part 120. In other words, the number of the first clamping parts 120 corresponds to the number of the bosses 121. The two bosses 121 are disposed in parallel to each other. The two bosses 121 may be symmetrically disposed with respect to the XoZ plane. The two bosses 121 themselves may be symmetrical with respect to the YoZ plane. The two bosses 121 are disposed horizontally and outwards, and each of the two first clamping parts 120 is located below the corresponding boss 121. Each of the two first clamping parts 120 is vertically located (e.g., the vertical direction is z-axis direction) below the corresponding boss 121. Each of the two first clamping parts 120 may be formed respectively by recessing upward from the bottom surface of the corresponding boss 121.

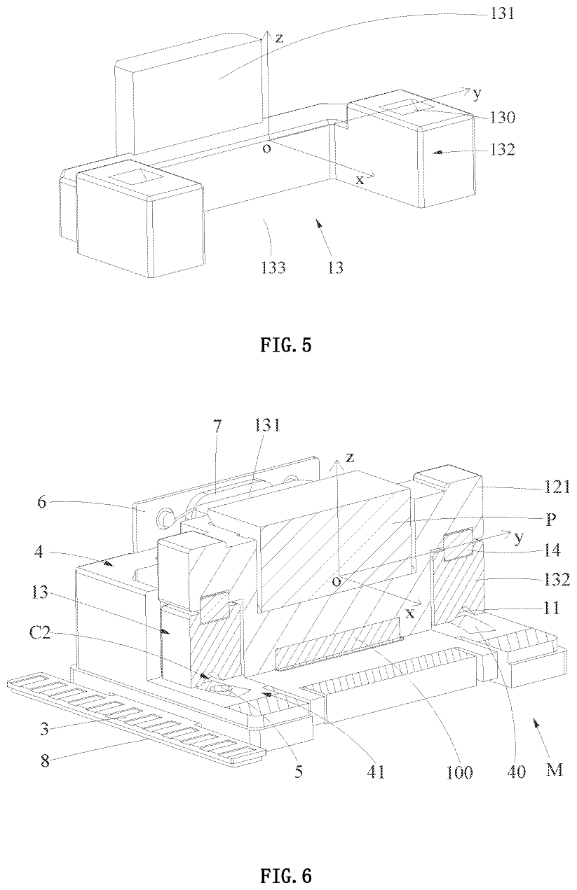

As shown in FIG. 5, in some embodiments, the second holder 13 further includes a backboard 131 and at least one arm 132 (e.g., two arms). The backboard 131 and the two arms 132 may be integrally formed with each other. The backboard 131 may be vertically disposed with the two arms 132. The two arms 132 may be cuboids. The two arms 132 are disposed at intervals, and the bottom of the first holder 12 (the first holder 12 may refer to FIG. 1, similarly hereinafter) may pass through a space between two arms. The two arms 132 may be parallel to each other, and the two arms 132 may be symmetrically disposed with respect to the XoZ plane. The two arms 132 are correspondingly disposed with the two bosses 121 respectively, and for example, each of the two arms 132 is disposed below the corresponding boss 121 (the boss 121 may refer to FIG. 2, similarly hereinafter), and each of the two arms 132 includes one second clamping part 130. The two arms 132 are disposed horizontally, the number of the second clamping parts 130 corresponds to the number of the arms 132, and each of the two second clamping parts 130 is located on the corresponding arm 132 respectively. Each of the two second clamping parts 130 may be formed by recessing downward from the top surface of the corresponding arm 132.

As shown in FIG. 6, the present disclosure in one embodiment provides a prismatic motor M for driving the prism P. The prismatic motor M includes: the holding component 1 (the holding component 1 may refer to FIG. 1, similarly hereinafter), rolling bodies 5 and a base 4. The prism P is disposed on the holding component 1, and the holding component 1 includes the magnetic body 10 (the magnetic body 10 may refer to FIG. 1, similarly hereinafter). The rolling bodies 5 contacts the holding component 1. The base 4 includes a magnetically permeable component 8, and the rolling bodies 5 are located between the holding component 1 and the base 4 and contact the base 4. The magnetically permeable component 8 is configured to attract the magnetic body 10 (e.g., to attract the first magnetic body 100) to increase the force of the holding component 1 interacting with the base 4, and in other words, the force of pressing the holding component 1 is increased.

As shown in FIG. 6, in some embodiments, a plenty of first accommodation parts 11 (e.g., three first accommodation parts) are disposed on the second holder 13, and the base 4 includes a plenty of second accommodation parts 40 (e.g., three second accommodation parts). Each of the plenty of second accommodation parts 40 is disposed below the corresponding first accommodation part 11, the plenty of second accommodation parts 40 are correspondingly disposed with the plenty of first accommodation parts 11, and the plenty of first accommodation parts 11 and the plenty of second accommodation parts 40 defines a plenty of rolling spaces which includes one free channel C1 and at least one (e.g., two) directional channel C2 (the free channel C1 and the directional channel C2 may refer to FIG. 1). The second holder 13 may rotate along each of the plenty of rolling spaces. The free channel C1 may be encircled by two circular blind holes, and each of the rolling bodies 5 may freely rotate in the free channel C1 (e.g., rotate in the x-axis direction and/or the y-axis direction). Each of the rolling bodies 5 may roll in the corresponding directional channel C2 along the corresponding directional channel C2, and the combined use of the rolling bodies 5 and the two directional channels C2 may direct the rotation direction of the second holder 13 such that the second holder 13 rotate along the two directional channels C2. Each of the first accommodation parts 11 and the corresponding second accommodation part 40 may be symmetrical with each other in shape by referring to a plane which passes through the center of the rolling body 5 and is vertical to the z-axis. Two first accommodation parts 11 of the plenty of first accommodation parts 11 may be respectively disposed on the corresponding arm 132, and for example, one first accommodation part 11 is disposed on the bottom of each of two arms 132. Each of the two directional channels C2 is encircled by the first accommodation part 11 disposed on each of two arms 132 and the corresponding second accommodation part 40. The base 4 includes a bottom plate 41 which may be disposed horizontally and be approximately parallel to the two arms 132 and the two bosses 121. The plenty of second accommodation parts 40 may be disposed on the bottom plate 41. Each of the rolling bodies 5 may be circular.

As shown in FIG. 6, the first accommodation part 11 and the second accommodation part 40 which form the directional channel C2 may be arc directional grooves. The first accommodation part 11 which forms the directional channel C2 may be formed by recessing upward from the bottom of the arm 132. The width of the cross section of the first accommodation part 11 which forms the directional channel C2 may be gradually decreased from the bottom of the arm 132 to the top of the arm 132. The width of the minimum cross section of the first accommodation part 11 which forms the directional channel C2 may be less than the radius of the rolling body 5.

As shown in FIG. 6, the second accommodation part 40 which forms the directional channel C2 may be formed by recessing downward from the surface of the bottom plate 41 of the base 4. The width of the cross section of the second accommodation part 40 which forms the directional channel C2 may be gradually decreased from the surface of the bottom plate 41 to the bottom of the bottom plate 41. The width of the minimum cross section of the second accommodation part 40 which forms the directional channel C2 may be less than the radius of the rolling body 5. The two directional channels C2 may be symmetrically disposed with respect to the XoZ plane. One axis line vertical to the bottom plate 41 is disposed, and the centers of the two directional channels C2 may be concentric and located on the aforementioned axis line. For example, the aforementioned axis line is the z-axis, and the second holder 13 may rotate along two directional channels C2, and in other words, the second holder 13 may rotate around the z-axis.

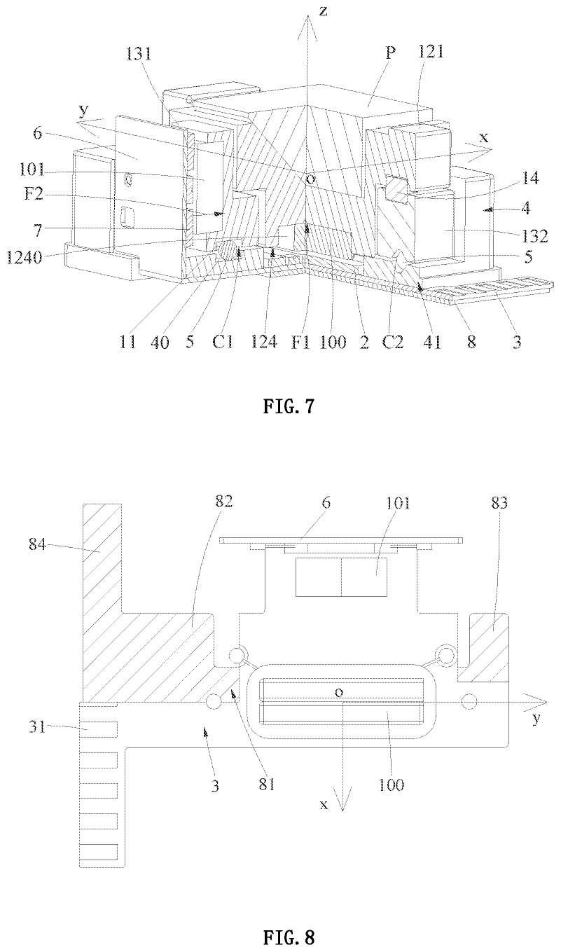

As shown in FIG. 7, the first accommodation part 11 and the second accommodation part 40 which form the free channel C1 may be blind holes. The diameter of the first accommodation part 11 and the diameter of the second accommodation part 40 are greater than the diameter of the rolling body 5. The depth of the first accommodation part 11 and the depth of the second accommodation part 40 are less than the radius of the rolling body 5. The free channel C1 itself may be symmetrical with respect to the XoZ plane.

As shown in FIG. 7, each of the rolling bodies 5 is located in the corresponding rolling space and may roll in the corresponding rolling space, and the second holder 13 may rotate along each of the plenty of rolling spaces, and each of the rolling bodies 5 respectively contacts the corresponding first accommodation part 11 and the corresponding second accommodation part 40. The rolling body 5 separates the base 4 from the holding component 1 (the holding component 1 may refer to FIG. 1, similarly hereinafter), and for example, the rolling body 5 separates the base 4 from the second holder 13 (the second holder 13 may refer to FIG. 5, similarly hereinafter). The second holder 13 and the base 4 don't contact with each other after the rolling body 5 separates the base 4 from the second holder 13, and for example, the bottom surface of the second holder 13 and the bottom plate 41 of the base 4 may be parallel to each other. The second holder 13 may rotate along the two directional channels C2. How the second holder 13 rotates along the two directional channels C2 may refer to the following embodiments.

Because the cylinder 14 is radially clamped between the first clamping part 120 and the second clamping part 130, the first holder 12 has face contact with the cylinder 14 such that the first holder 12 relative to the second holder 13 merely rotate around the y-axis, and when the second holder 13 rotates around the z-axis, the first holder 12 relative to the second holder 13 would not rotate around the other directions (e.g. not rotate around the x-axis or the z-axis) and the rotation error would not be generated so that the first holder 12 relative to the second holder 13 may keep stable and further the control of the rotation of the prism P would be more precise when the prism P rotates around the z-axis.

As shown in FIG. 7, in some embodiments, the first magnetic body 100 is disposed on the first holder 12 (the first holder 12 may refer to FIG. 4, similarly hereinafter). The first magnetic body 100, the first coil 2 and the first circuit board 3 may be disposed in parallel to each other. The first coil 2 may include an iron core to strengthen first magnetic force F1. An accommodation groove 1240 may be disposed on the bottom of the first holder 12, and the first magnetic body 100 is disposed in the accommodation groove 1240. For example, a platform 124 may be disposed on the bottom of the first holder 12 and may be parallel to the bottom plate 41 of the base 4. The first magnetic body 100 may be disposed on the platform 124 of the bottom of the first holder 12. The accommodation groove 1240 may be disposed on the platform 124, and the first magnetic body 100 may be disposed (e.g., attached) inside the accommodation groove 1240. The accommodation groove 1240 may be a rectangle hole. The first magnetic body 100 may be attached to the first holder 12.

As shown in FIG. 7, the first circuit board 3 includes the first coil 2 which is corresponding disposed with the first magnetic body 100. The first coil 2 is configured to generate the first magnetic force F1 interacting with the first magnetic body 100 when the first coil 2 is charged with electricity in order to push the first holder 12 (the first holder 12 may refer to FIG. 4, similarly hereinafter) to rotate along the circumference direction of the cylinder 14. The first coil 2 is disposed on one surface of the first circuit board 3 close to the first magnetic body 100, and the magnetically permeable component 8 is disposed on one surface of the first circuit board 3 far from the first magnetic body 100. The first circuit board 3 is disposed on the base 4, and for example, the first circuit board 3 is connected to the base 4 and may be fixed on the bottom plate 41 by screws or rivets. The first circuit board 3 may be disposed in parallel to the bottom plate 41. The direction of the first magnetic force F1 may be a direction parallel to the z-axis. For example, when the number of the first magnetic bodies 100 is two and the magnetic poles of the bottom surfaces of the two first magnetic bodies 100 are reverse (the disposal of the two first magnetic bodies 100 may refer to the following embodiments), the first magnetic force F1 may attract one of the two first magnetic bodies 100 and repels the other first magnetic body 100 such that the first holder 12 rotates along the circumference direction of the cylinders 14 (e.g., rotate along the y-axis). The change of the current direction to the first coil 2 may change the direction of the first magnetic force F1 so that the first holder 12 may be switched between clockwise rotation and counterclockwise rotation along the circumference direction of the cylinder 14. A through hole may be disposed on the bottom plate 41 such that the first coil 2 faces the first magnetic body 100 by the through hole to avoid decreasing the magnetic field of the first coil 2 due to the blocking of the bottom plate 41. The magnitude of the first magnetic force F1 may depend upon appropriate requirements to push the first holder 12, the prism P and the first magnetic bodies 100 to rotate along the circumference direction of the cylinder 14.

As shown in FIG. 7, the second circuit board 6 is connected to the base 4. The second circuit board 6 includes a second coil 7. The second coil 7 may include an iron core to strengthen second magnetic force F2. The second magnetic body 101, the second coil 7 and the second circuit board 6 may be disposed in parallel to each other. The second circuit board 6 may be fixed on the side face of the base 4 by screws or rivets. A notch may be disposed on the side face of the base 4, and the second coil 7 may face the second magnetic body 101 by the notch on the side face of the base 4 to avoid decreasing the magnetic field of the second coil 7 due to the blocking of the side face of the base 4. Two second magnetic bodies 101 (the disposal of the two second magnetic bodies 101 may refer to the following embodiments) may be disposed (e.g., attached) on the backboard 131 of the second holder 13, and the two second magnetic bodies 101 may be symmetrically disposed with respect to XoZ plane.

As shown in FIG. 7, the second magnetic body 101 is disposed on the second holder 13 (the second holder 13 may refer to FIG. 5, similarly hereinafter) and corresponds to the second coil 7. The second coil 7 is configured to generate the second magnetic force F2 interacting with the second magnetic body 101 when the second coil 7 is charged with electricity in order to push the second holder 13 to rotate, and for example, to push the second holder 13 to rotate along the two directional channels C2. The direction of the second magnetic force F2 may be a direction parallel to the x-axis. For example, when the number of the second magnetic bodies 101 is two and the magnetic poles of the bottom surfaces of the two second magnetic bodies 101 are reverse, the second magnetic force F2 may attract one of the two second magnetic bodies 101 and repels the other second magnetic body 101 such that the second holder 13 rotates along the two directional channels C2 and further the second holder 13 may drive the first holder 12 (the first holder 12 may refer to FIG. 4, similarly hereinafter) and the prism along the two directional channels C2. The change of the current direction to the second coil 7 may change the direction of the second magnetic force F2 so that the second holder 13 may be switched between the clockwise rotation and the counterclockwise rotation along the two directional channels C2. The second circuit board 6 may be vertically disposed with the first circuit board 3, and the second magnetic bodies 101 may be attached to the second holder 13. The magnitude of the second magnetic force F2 may depend upon appropriate requirements to push the first holder 12, the second holder 13, the prism P, the first magnetic bodies 100 and the second magnetic bodies 101 to rotate along the two directional channels C2.

As shown in FIG. 3 to FIG. 7, in some embodiments, the second holder 13 further includes a backboard 131, there is an avoidance space 133 formed between the backboard 131 and the two arms 132 located on two sides of the backboard 131, and the first holder 12 is disposed in the avoidance space 133. The backboard 131 and the two arms 132 encircle the first holder 12, and the platform 124 on the bottom of the first holder 12 approaches the first circuit board 3 of the base 4 by passing through the avoidance space 133, and the first magnetic bodies 100 on the platform 124 and the first coil 2 on the first circuit board 3 approach with each other, and the second magnetic body 101 on the backboard 131 of the second holder 13 and the second coil 7 of the second circuit board 6 on the side face of the base 4 approach with each other. In the present embodiment, there is a gap between the first magnetic body 100 and the first coil 2, and there is no other components in the gap: there is a gap between the second magnetic body 101 and the second coil 7, and there is no other components in the gap. The first holder 12 is directly driven by the first coil 2 through the first magnetic body 100, and the second holder 13 is directly driven by the second coil 7 through the second magnetic body 101. By the aforementioned configuration, the component configuration is more compact and the needed space may be decreased: and the driving of the first holder 12 and the driving of the second holder 13 are independent, and the interference may be reduced and sensitivity and stability would be increased.

As shown in FIG. 7, the magnetically permeable component 8 is configured to attract the magnetic body 10 (the magnetic body 10 may refer to FIG. 1) to increase the force of the holding component 1 (the holding component 1 may refer to FIG. 1) interacting with the base 4. The magnetically permeable component 8 is disposed on the base 4, and for example, the magnetically permeable component 8 is disposed below the base 4 and the magnetically permeable component 8 is correspondingly disposed with the first magnetic bodies 100. The magnetically permeable component 8 may be flaky or the other shapes, and one part of the magnetically permeable component 8 may be located directly below the first magnetic bodies 100. The magnetically permeable component 8 does not have magnetism, and the magnetically permeable component 8 is magnetized to generate magnetic force after the magnetically permeable component 8 is placed in the magnetic field, and the magnetically permeable component 8 may be made up of silicon steel sheets, nickel steel sheets, soft iron, A3 steel or soft magnetic alloys. The first circuit board 3 may be located between the magnetically permeable component 8 and the bottom plate 41, and the magnetically permeable component 8 may generate force of attraction under the magnetic field of the first magnetic bodies 100 to press the first magnetic body 100, and further the first holder 12 (the first holder 12 may refer to FIG. 4, similarly hereinafter) is pressed toward the bottom plate 41 of the base 4 such that the first holder 12 and the second holder 13 (the second holder 13 may refer to FIG. 5, similarly hereinafter) could be stably disposed on the base 4. After the cylinders 14, the rolling bodies 5 and the first magnetic bodies 100 are mounted on the corresponding positions, the cylinder 14 may be stably clamped between the first clamping part 120 and the second clamping part 130 (the first clamping part 120 and the second clamping part 130 may refer to FIG. 2) by the force generated by the magnetically permeable component 8 and would not be dropped on the ground.

As shown in FIG. 8, the magnetically permeable component 8 includes a main body 81, a first extension part 82, a second extension part 83 and a support part 84, and the main body 81 is correspondingly disposed with the first magnetic body 100. For example, the main body 81 may be disposed below the first magnetic body 100. The first extension part 82 and the second extension part 83 are respectively on relative two sides of the main body 81. For example, the first extension part 82 and the second extension part 83 may be respectively on a left side and a right side of the first magnetic body 100. The first extension part 82 and the second extension part 83 extend along the relative two sides of the second magnetic body 101. For example, the first extension part 82 and the second extension part 83 may extend along the x-axis direction. There are contact points 31 disposed on one side of the first circuit board 3 and arranged along a predetermined direction (e.g., along x-axis direction). The support part 84 is located on one side of the first extension part 82 far from the main body 81 and being correspondingly disposed with the contact points 31. The contact points 31 may be connection fingers. The support part 84 may be located below the contact points 31 to strengthen the contact points 31.

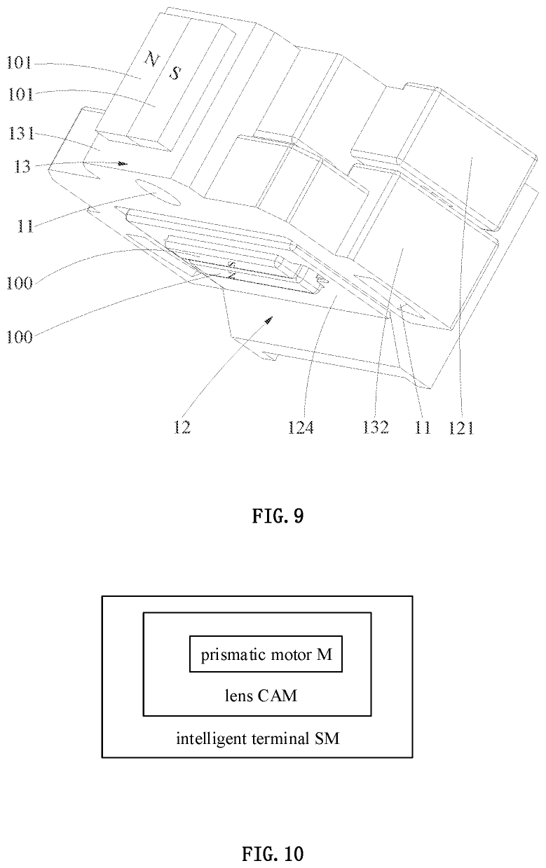

As shown in FIG. 9, the first magnetic bodies 100 may be magnets, and the number of the first magnetic bodies 100 is two, and the magnetic poles of the bottom surfaces of the two first magnetic bodies 100 are reverse. For example, the bottom surface of one of the two first magnetic bodies 100 may be a south magnetic pole and the bottom surface of the other first magnetic body 100 may be a north magnetic pole, and the bottom surfaces of the two first magnetic bodies 100 face the first coil 2 (the first coil 2 may refer to FIG. 7).

As shown in FIG. 9, the second magnetic bodies 101 may be magnets, and the number of the second magnetic bodies 101 is two, and the magnetic poles of the side surfaces of the two second magnetic bodies 101 are reverse. For example, the side surface of one of the two second magnetic bodies 101 may be a south magnetic pole and the side surface of the other the second magnetic body 101 may be a north magnetic pole, and the side surfaces of the two second magnetic bodies 101 face the second coil 7 (the second coil 7 may refer to FIG. 7).

The magnetically permeable component 8 is disposed on the base 4, and the magnetically permeable component 8 is utilized to attract the magnetic body 10 in the holding component 1, thereby increasing the force of the holding component 1 interacting with the base 4. Hence, when the rolling body 5 is mounted between the base 4 and the holding component 1, the rolling body 5 would be kept between the base 4 and the holding component 1 and would not be dropped out of the prismatic motor M due to the attraction of the magnetically permeable component 8 interacting with the holding component 1, and it is convenient for the rolling body 5 to mount.

As shown in FIG. 1, a case 9 is covered on the base 4. The case 9 may be a rectangular shape, and notches may be disposed on the top surface and one side surface of the case 9 to expose the prism P. An opening is disposed on the bottom surface of the case 9, and the opening on the bottom surface of the case 9 may be covered by the bottom plate 41 of the base 4 (the bottom plate 41 may refer to FIG. 6) and the first circuit board 3. The bosses 121 and the arms 132 (the bosses 121 and the arms 132 may refer to FIG. 6) may be located between the top surface of the case 9 and the bottom surface of the case 9. The side surface of the case 9 facing the prism P may cover the second circuit board 6, the second magnetic body 101 and the second coil 7.

As shown in FIG. 10, the present disclosure in another embodiment provides a camera CAM including the prismatic motor M in the aforementioned embodiment. External light may enter the camera CAM by the prism P on the prismatic motor M.

As shown in FIG. 10, the present disclosure in another embodiment provides an intelligent terminal SM including the camera CAM in the aforementioned embodiment. The intelligent terminal SM may be a smart phone or a panel computer.

The prismatic motor provided by the embodiments of the present disclosure is described in detail by the above description. A person skilled in the art would have changes in specific implementation and application scope according to the idea of the embodiments of the present disclosure. In view of the above description, the content of the present disclosure should not be construed as limitations of the present disclosure, and equivalent modification or changes according to the idea and the spirit of the present disclosure should be construed as being included within the scope of the present disclosure.

### LIST OF REFERENCE SIGNS

1: holding component
10: magnetic body
100: first magnetic body
101: second magnetic body
11: first accommodation part
12: first holder
120: first clamping part
1200: first groove bottom surface
121: boss
122: side plate
123: slanted plate
124: platform
1240: accommodation groove
13: second holder
130: second clamping part
1300: second groove bottom surface
1301: slanted surface
131: backboard
132: arm
133: avoidance space
14: cylinder
2: first coil
3: first circuit board
31: contact point
4: base
40: second accommodation part
41: bottom plate
5: rolling body
6: second circuit board
7: second coil
8: magnetically permeable component
81: main body
82: first extension part
83: second extension part
84: support part
9: case
P: prism
F1: first magnetic force
F2: second magnetic force
C1: free channel
C2: directional channel
M: prismatic motor
CAM: camera
SM: intelligent terminal

1. A prismatic motor for driving a prism comprising:
a first holder for holding the prism, the first holder comprising a first clamping part;
a second holder comprising a second clamping part which is correspondingly disposed with the first clamping part; and
a cylinder located between the first clamping part and the second clamping part and radially separating the first holder from the second holder, wherein, the first holder is configured to rotate along a circumference direction of the cylinder.

2. The prismatic motor according to claim 1, wherein the first holder further comprises a boss which protrudes outwards, the first clamping part is located on the boss, and the first holder is for holding the prism on a direction opposite to a protruding direction of the boss.

3. The prismatic motor according to claim 2, wherein a number of the bosses is two and the two bosses are disposed horizontally and outwards, the first holder is for holding the prism between the two bosses, a number of the first clamping parts corresponds to the number of the bosses, and the first clamping part is vertically located below the boss and the second clamping part is vertically located above the second holder.

4. The prismatic motor according to claim 2, wherein the second holder comprises an arm which is correspondingly disposed with the boss, and the second clamping part is located on the arm.

5. The prismatic motor according to claim 4, wherein a number of the arms is two and corresponds to a number of the second clamping parts, and the two arms are disposed horizontally.

6. The prismatic motor according to claim 5, wherein a number of the cylinders is two and corresponds to the number of the first clamping parts and the number of the second clamping parts, and the two cylinders are coaxially disposed.

7. The prismatic motor according to claim 1, wherein the first clamping part is a concave groove with rectangular cross-section, and the second clamping part is a concave groove with trapezoidal cross-section.

8. The prismatic motor according to claim 7, wherein the first clamping part comprises a first groove bottom surface, the second clamping part comprises a second groove bottom surface and two slanted surfaces which are relatively disposed and are connected to the second groove bottom surface, the first groove bottom surface and the two slanted surfaces are respectively in line contact with the cylinder, and there is a gap between the cylinder and the second groove bottom surface.

9. The prismatic motor according to claim 1, further comprising:
a base;
a first magnetic body disposed on the first holder; and
a first circuit board disposed on the base and comprising a first coil, the first coil corresponding to the first magnetic body and being configured to generate first magnetic force interacting with the first magnetic body after the first coil is charged with electricity in order to push the first holder to rotate along a circumference direction of the cylinder.

10. The prismatic motor according to claim 9, further comprising a magnetically permeable component which is disposed on the base and is correspondingly disposed with the first magnetic body.

11. The prismatic motor according to claim 10, wherein the first coil is disposed on one surface of the first circuit board close to the first magnetic body, and the magnetically permeable component is disposed on one surface of the first circuit board far from the first magnetic body.

12. The prismatic motor according to claim 10, further comprising:
a second circuit board which comprises a second coil; and
a second magnetic body disposed on the second holder and corresponding to the second coil, wherein the second coil is configured to generate second magnetic force interacting with the second magnetic body after the second coil is charged with electricity in order to push the second holder to rotate;
wherein the magnetically permeable component comprises a main body, a first extension part and a second extension part, the main body is correspondingly disposed with the first magnetic body, the first extension part and the second extension part are respectively on relative two sides of the main body, and the first extension part and the second extension part extend along the relative two sides of the second magnetic body.

13. The prismatic motor according to claim 12, wherein there are contact points disposed on one side of the first circuit board and arranged along a predetermined direction, and the magnetically permeable component further comprises a support part located on one side of the first extension part far from the main body and being correspondingly disposed with the contact points.

14. The prismatic motor according to claim 1, further comprising:
a first accommodation part disposed on the second holder;
a second accommodation part being correspondingly disposed with the first accommodation part and defining a rolling space with the first accommodation part; and
a rolling body located in the rolling space, wherein the rolling body is configured to roll in the rolling space, and the second holder is configured to rotate along the rolling space.

15. The prismatic motor according to claim 14, wherein a number of the first accommodation parts and a number of the second accommodation parts are respectively two, a number of the rolling spaces is two, the two rolling spaces comprise at least one directional channel, the rolling body is configured to roll in the directional channel, and the second holder is configured to rotate along the directional channel.

16. The prismatic motor according to claim 15, further comprising:
a second circuit board which comprises a second coil; and
a second magnetic body disposed on the second holder and corresponding to the second coil, wherein the second coil is configured to generate second magnetic force interacting with the second magnetic body after the second coil is charged with electricity in order to push the second holder to rotate along the directional channel.

17. The prismatic motor according to claim 1, wherein the first holder further comprises two bosses disposed horizontally and outwards, the first holder is for holding the prism between the two bosses; the second holder further comprises a backboard and two arms respectively located on two sides of the backboard, there is an avoidance space formed between the backboard and the two arms, the first holder is disposed in the avoidance space, and the two arms are correspondingly disposed with the two bosses respectively.

18. The prismatic motor according to claim 17, further comprising:
a base;
a first magnetic body disposed on a platform of a bottom of the first holder; and
a first circuit board disposed on the base and comprising a first coil, wherein the first coil is correspondingly disposed with the first magnetic body, wherein the platform approaches the first circuit board by the avoidance space, the first magnetic body is close to the first coil, and there is a gap between the first magnetic body and the first coil.

19. The prismatic motor according to claim 18, further comprising:
a second circuit board which comprises a second coil; and
a second magnetic body disposed on the backboard of the second holder and corresponding to the second coil, wherein the second magnetic body is close to the second coil, and there is a gap between the second magnetic body and the second coil.

20. A prismatic motor for driving a prism comprising:
a first holder comprising two bosses and two first clamping parts, wherein the two bosses are disposed horizontally and outwards, the first holder is for holding the prism between the two bosses, and the two first clamping parts are located on the two bosses respectively; and
a second holder which comprises a backboard, two arms located on two sides of the backboard, and two second clamping parts located on the two arms respectively, wherein there is an avoidance space formed between the backboard and the two arms, the first holder is disposed in the avoidance space, the two arms are correspondingly disposed with the two bosses respectively, the second clamping part is rotatably connected to the first clamping part, and the first holder is configured to rotate relative to the second holder by the first clamping part and the second clamping part.
